(19) United States
(12) Patent Application Publication
(10) Pub. No.: US 2022/0308295 A1
(43) Pub. Date: Sep. 29, 2022

(54) OPTICAL PATH CONVERSION COMPONENT-EQUIPPED CIRCUIT BOARD AND WIRING MODULE TO BE MOUNTED ON CIRCUIT BOARD

(71) Applicant: SUMITOMO ELECTRIC INDUSTRIES, LTD., Osaka-shi, Osaka (JP)

(72) Inventors: Hong Chuyen NGUYEN, Osaka-shi (JP); Tetsuya NAKANISHI, Osaka-shi (JP); Tsutaru KUMAGAI, Osaka-shi (JP)

(73) Assignee: SUMITOMO ELECTRIC INDUSTRIES, LTD., Osaka-shi, Osaka (JP)

(21) Appl. No.: 17/608,407

(22) PCT Filed: Apr. 12, 2021
(86) PCT No.: PCT/JP2021/015156

§ 371 Date: Nov. 2, 2021

(30) Foreign Application Priority Data
Apr. 16, 2020 (JP) 2020-073428

(51) Int. Cl. G02B 6/42

(52) U.S. Cl. CPC G02B 6/4214; G02B 6/4218; G02B 6/428

(57) ABSTRACT

A circuit board with an optical path conversion component includes a circuit board having a main surface, an optical path conversion component connected to the circuit board, and one or more first fiber ribbons. Each of the one or more first fiber ribbons has a first end and a second end, and includes a plurality of optical fibers optically coupled to the conversion component at the first end. The one or more first fiber ribbons extend in a direction crossing a normal of the main surface. The conversion component has at least one channel group for each of the one or more first fiber ribbons, the at least one channel group including a plurality of channels optically coupled respectively to the plurality of optical fibers. The plurality of channels are arranged in a direction crossing the main surface for each of the at least one channel group.

### TECHNICAL FIELD

The present disclosure relates to a circuit board with an optical path conversion component and a wiring module for mounting on a circuit board. The present application claims the benefit of the priority based on Japanese Patent Application No. 2020-073428 filed on Apr. 16, 2020, the entire contents described in the application is incorporated herein by reference.

### BACKGROUND ART

Patent Literature 1 discloses a technique regarding an optical connector. The optical connector is a horizontal optical connector that connects a plurality of optical fibers in parallel to the connection target surface, and achieves optical coupling between the optical fiber and a photoelectric conversion element in a state in which the optical connector is mounted on a substrate on which the photoelectric conversion element is disposed. In an optical transmission cable connected to the optical connector, a plurality of optical fibers have a direction along the substrate surface as a main arrangement direction.

### CITATION LIST

### Patent Literature

Patent Literature 1: Japanese Unexamined Patent Publication No. 2017-134282

### SUMMARY OF INVENTION

A circuit board with an optical path conversion component according to an embodiment includes a circuit board having a main surface, an optical path conversion component connected to the circuit board, and one or more first fiber ribbons. Each of the one or more first fiber ribbons has a first end and a second end, and includes a plurality of optical fibers optically coupled to the optical path conversion component at the first end. The one or more first fiber ribbons extend in a direction crossing a normal of the main surface. The optical path conversion component has at least one channel group for each of the one or more first fiber ribbons and the at least one channel group includes a plurality of channels optically coupled respectively to the plurality of optical fibers. The plurality of channels are arranged in a direction crossing the main surface for each of the at least one channel group.

A wiring module for mounting on a circuit board according to an embodiment includes an optical path conversion component and one or more first fiber ribbons. The optical path conversion component has a bottom surface, and is configured to be mounted on a main surface of a circuit board. Each of the one or more first fiber ribbons has a first end and a second end, and includes a plurality of optical fibers optically coupled to the optical path conversion component at the first end. The optical path conversion component has at least one channel group for each of the one or more first fiber ribbons and the at least one channel group includes a plurality of channels optically coupled respectively to the plurality of optical fibers. The plurality of channels are arranged in a direction crossing the bottom surface for each of the at least one channel group.

### BRIEF DESCRIPTION OF DRAWINGS

FIG. 1 is a perspective view schematically showing a circuit board with an optical path conversion component according to an embodiment of the present disclosure.

FIG. 2 is a cross-sectional view along the line II-II shown in FIG. 1, and shows the cross sections of fiber ribbons and a circuit board.

FIG. 3 is a front view showing an optical fiber connection surface of the optical path conversion component.

FIG. 4 is a side view of the optical path conversion component.

FIG. 5 is a perspective view showing a wiring module according to a comparative example.

FIG. 6 is a perspective view showing the configuration of a circuit board with an optical path conversion component according to a first modification example.

FIG. 7 is a perspective view showing a wiring module according to a comparative example.

FIG. 8 is a perspective view showing a fiber ribbon according to a second modification example.

FIG. 9 is a diagram schematically showing a cross section of an optical fiber perpendicular to an optical axis direction.

FIG. 10 is a diagram showing how a polarization maintaining fiber is bent in a direction along a fast axis.

FIG. 11 is a diagram schematically showing an optical path conversion component, fiber ribbons, and multi-fiber optical connectors according to a third modification example.

FIG. 12 is a diagram showing, as a comparative example, a case where the number of channels arranged along a direction D1 in an optical path conversion component is different from the sum of the number of channels forming each of channel groups arranged along the direction D1.

FIG. 13 is a perspective view showing the configuration of a circuit board with an optical path conversion component according to a fourth modification example.

FIG. 14 is a side view of an optical path conversion component.

FIG. 15 is a diagram showing a harness according to a fifth modification example.

FIG. 16 is a diagram showing a harness according to a sixth modification example.

FIG. 17 is a diagram schematically showing the configuration of a fiber ribbon according to a seventh modification example.

### DESCRIPTION OF EMBODIMENTS

### Problems to be Solved by the Present Disclosure

In recent years, as the amount of signals transmitted and received between circuit boards or between a circuit board and another device increases, it has been thought about transmitting signals between these through an optical fiber. In this case, it is necessary to provide an optical device, such as a light receiving element, a light emitting element, or an optical waveguide, on the circuit board and to connect an optical fiber to the optical device. At this time, if the optical fiber is extended in a direction crossing a board surface of the circuit board, a large space is required for the arrangement of the optical fiber. Therefore, it is conceivable to extend the optical fiber in a direction along the board surface of the circuit board. In addition, when connecting a plurality of optical fibers and a plurality of optical devices, as shown in Patent Literature 1, a method of arranging the plurality of optical fibers with the direction along the board surface as a main arrangement direction can be considered.

In this case, however, if a fiber ribbon is used in order to improve the handling of the plurality of optical fibers, the following problem occurs. Generally, the fiber ribbon has a characteristic that the flexibility in a thickness direction, that is, a direction crossing an arrangement surface of the optical fiber, is high and the flexibility in a width direction, that is, the arrangement direction of the optical fiber, is low. When a plurality of optical fibers are arranged with the direction along the board surface as a main arrangement direction, the width direction of the fiber ribbon is along the board surface. Therefore, it is difficult to bend the fiber ribbon in a direction parallel to the board surface, which imposes restrictions on the design of the circuit board. Even if the fiber ribbon can be bent by twisting, there is a concern that the transmission loss may increase due to the torsional stress.

### Effect of the Present Disclosure

According to the present disclosure, it is possible to provide a circuit board with an optical path conversion component and a wiring module for mounting on a circuit board allowing a fiber ribbon to be easily bent in a direction parallel to the board surface of the circuit board.

### Description of Embodiments of the Present Disclosure

First, embodiments of the present disclosure will be listed and described. A circuit board with an optical path conversion component according to an embodiment includes a circuit board having a main surface, an optical path conversion component connected to the circuit board, and one or more first fiber ribbons. Each of the one or more first fiber ribbons has a first end and a second end, and includes a plurality of optical fibers optically coupled to the optical path conversion component at the first end. The one or more first fiber ribbons extend in a direction crossing a normal of the main surface. The optical path conversion component has at least one channel group for each of the one or more first fiber ribbons and the at least one channel group includes a plurality of channels optically coupled respectively to the plurality of optical fibers. The plurality of channels are arranged in a direction crossing the main surface for each of the at least one channel group.

In the circuit board with an optical path conversion component, the first fiber ribbon extends from the optical path conversion component in a direction crossing the normal of the main surface of the circuit board in such a manner that the thickness direction crosses the normal of the main surface. Therefore, the first fiber ribbon can be easily bent in a direction parallel to the board surface (the main surface) of the circuit board. As a result, the restrictions on the design of the circuit board can be reduced, and the increase in transmission loss can be suppressed.

In the circuit board with an optical path conversion component described above, the optical path conversion component may have first optical paths extending from the plurality of channels in parallel with an optical axis of the respective optical fibers, second optical paths extending from an optical device provided on the main surface in a direction crossing the main surface, and an optical path converting portion for connecting the first and second optical paths to each other, and may optically couple the optical device to the plurality of optical fibers. Alternatively, the optical path conversion component may have first optical paths extending from the plurality of channels in parallel with an optical axis of the respective optical fibers, second optical paths extending from an optical device provided on the main surface in parallel with the main surface, and an optical path converting portion for connecting the first and second optical paths to each other, and may optically couple the optical device to the plurality of optical fibers. In any of these cases, the optical device on the circuit board can be efficiently coupled to the plurality of optical fibers. In these cases, the optical path converting portion may comprise at least one light reflecting surface.

In the circuit board with an optical path conversion component described above, the one or more first fiber ribbons extend in an inclination direction within 45° with respect to the main surface.

In the circuit board with an optical path conversion component described above, the at least one channel group may include at least two first channel groups arranged in a direction along the main surface. In this case, since the plurality of first fiber ribbons are arranged so as to overlap each other in the thickness direction, the wiring density of the first fiber ribbons can be increased. In addition, when a multi-fiber optical connector is attached to the second end of the one or more first fiber ribbons, the first fiber ribbons are easily bent in the arrangement direction. Therefore, regardless of the size of the multi-fiber optical connector, a plurality of channel groups of the optical path conversion component can be densely arranged. This can contribute to the miniaturization of the optical path conversion component.

In the circuit board with an optical path conversion component described above, the at least one channel group may include at least two second channel groups arranged in a direction crossing the main surface. In this case, the space on the circuit board can be effectively used to increase the wiring density of the first fiber ribbons.

In these cases, a total number of channels arranged in a direction crossing the main surface in the optical path conversion component may be equal to a total number of channels forming each of the at least one channel group in the direction crossing the main surface. As a result, all the channels arranged in the direction crossing the main surface of the circuit board are connected to any of the first fiber ribbons, and there is no surplus in the channels. Therefore, it is possible to improve the space utilization efficiency of the optical path conversion component to contribute to the miniaturization of the optical path conversion component.

In the circuit board with an optical path conversion component described above, plurality of optical fibers forming at least one first fiber ribbon among the one or more first fiber ribbons include at least one stress-applied type polarization maintaining fiber. Then, a fast axis of the polarization maintaining fiber may be along an arrangement direction of the plurality of optical fibers forming the at least one first fiber ribbon including the polarization maintaining fiber. In this case, since the thickness direction of the first fiber ribbon crosses the fast axis of the polarization maintaining fiber, the polarization maintaining fiber is bent mainly in a direction crossing the fast axis. Therefore, since the birefringence increases in a state in which the polarization maintaining fiber is bent, it is possible to suppress the increase in polarization crosstalk.

In the circuit board with an optical path conversion component described above, a first multi-fiber optical connector may be attached to the second end of at least one first fiber ribbon among the one or more first fiber ribbons. In this case, the first fiber ribbon and another fiber ribbon can be easily connected to each other.

The circuit board with an optical path conversion component may further include a harness in which a plurality of second fiber ribbons each having a first end and a second end are bundled. Then, a second multi-fiber optical connector may be attached to the first end of at least one second fiber ribbon among the plurality of second fiber ribbons, and the second multi-fiber optical connector may be connected to the first multi-fiber optical connector. By providing such a harness on the circuit board with an optical path conversion component, a complicated optical connection structure can be easily assembled on the circuit board.

The circuit board with an optical path conversion component may include a harness in which the at least one first fiber ribbon having the first multi-fiber optical connector and one or more third fiber ribbons are bundled. By providing such a harness on the circuit board with an optical path conversion component, a complicated optical connection structure can be easily assembled on the circuit board.

A wiring module for mounting on a circuit board according to one aspect includes an optical path conversion component and one or more first fiber ribbons. The optical path conversion component has a bottom surface, and is configured to be mounted on a main surface of a circuit board. Each of the one or more first fiber ribbons has a first end and a second end, and includes a plurality of optical fibers optically coupled to the optical path conversion component at the first end. The optical path conversion component has at least one channel group for each of the one or more first fiber ribbons and the at least one channel group includes a plurality of channels optically coupled respectively to the plurality of optical fibers. The plurality of channels are arranged in a direction crossing the bottom surface for each of the at least one channel group.

In the wiring module for mounting on a circuit board, the first fiber ribbon is arranged so that the thickness direction crosses the normal of the main surface of the circuit board. Therefore, the first fiber ribbon can be easily bent in a direction parallel to the board surface (the main surface) of the circuit board. As a result, the restrictions on the design of the circuit board can be reduced, and the increase in transmission loss can be suppressed.

In the wiring module for mounting on a circuit board described above, the optical path conversion component may have first optical paths extending from the plurality of channels in parallel with an optical axis of the respective optical fibers, second optical paths extending in a direction crossing the bottom surface, and an optical path converting portion for connecting the first and second optical paths to each other. In this case, the optical device facing the bottom surface of the optical path conversion component can be efficiently coupled to the plurality of optical fibers. In this case, the optical path converting portion may comprise at least one light reflecting surface.

In the wiring module for mounting on a circuit board described above, the at least one channel group may include at least two channel groups arranged in a direction along the bottom surface. In this case, since the plurality of first fiber ribbons are arranged so as to overlap each other in the thickness direction, the wiring density of the first fiber ribbons can be increased. In addition, when a multi-fiber optical connector is attached to the second end of the one or more first fiber ribbons, the first fiber ribbons are easily bent in the arrangement direction. Therefore, regardless of the size of the multi-fiber optical connector, a plurality of channel groups of the optical path conversion component can be densely arranged. This can contribute to the miniaturization of the optical path conversion component.

In the wiring module for mounting on a circuit board described above, plurality of optical fibers forming at least one first fiber ribbon among the one or more first fiber ribbons include at least one a stress-applied type polarization maintaining fiber. Then, a fast axis of the polarization maintaining fiber may be along an arrangement direction of the plurality of optical fibers forming the at least one first fiber ribbon including the polarization maintaining fiber. In this case, since the thickness direction of the first fiber ribbon crosses the fast axis of the polarization maintaining fiber, the polarization maintaining fiber is bent mainly in a direction crossing the fast axis. Therefore, since the birefringence increases in a state in which the polarization maintaining fiber is bent, it is possible to suppress the increase in polarization crosstalk.

### Details of Embodiments of the Present Disclosure

Circuit board with an optical path conversion component and a wiring module for mounting on a circuit board according to embodiments of the present disclosure will be described below with reference to the drawings. The present invention is not limited to these examples. The present invention is indicated by the claims, and it is intended to include all the changes within meaning and a range equivalent to the claims. In the following description, the same elements are denoted by the same reference numerals in the description of the drawings, and the repeated description thereof will be omitted.

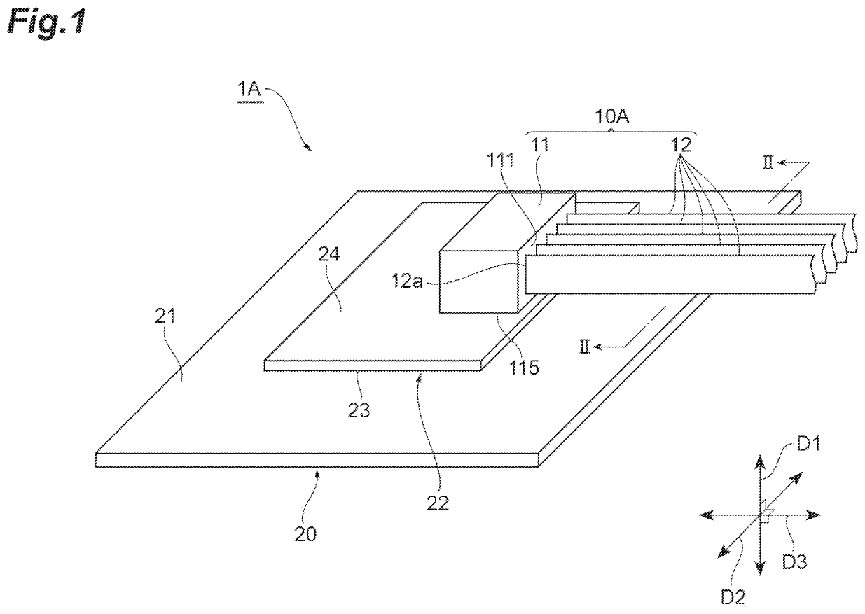

FIG. 1 is a perspective view schematically showing a circuit board with an optical path conversion component (hereinafter, simply referred to as a mounting circuit board) 1A according to an embodiment of the present disclosure. As shown in FIG. 1, the mounting circuit board 1A of the present embodiment includes a wiring module for mounting on a circuit board (hereinafter, simply referred to as a wiring module) 10A and a circuit board 20. The circuit board 20 is a flat plate shaped member having a main surface 21, and an optical device 22 is mounted on the main surface 21. The optical device 22 may include, for example, at least one of a semiconductor light receiving element such as a photodiode, a semiconductor light emitting element such as a laser diode or an LED, and an optical waveguide chip. The optical device 22 of the present embodiment has a back surface 23 facing the main surface 21 of the circuit board 20 and a surface 24 facing a side opposite to the back surface 23 (that is, in the same direction as the main surface 21). The optical device 22 has a plurality of optical ports for the input and output of continuous light or an optical signal on the surface 24.

The wiring module 10A includes an optical path conversion component 11 and one or more (five in the illustrated example) fiber ribbons 12. The optical path conversion component 11 is mounted on the main surface 21 of the circuit board 20 and connected to the circuit board 20. Specifically, the optical path conversion component 11 has an optical fiber connection surface 111 and a bottom surface 115. The normal direction of the optical fiber connection surface 111 and the normal direction of the bottom surface 115 cross each other. The optical fiber connection surface 111 extends in a direction crossing the main surface 21. The bottom surface 115 faces the main surface 21 and is parallel to the main surface 21. In the illustrated example, the bottom surface 115 faces the surface 24 of the optical device 22 and is optically coupled to a plurality of optical ports provided on the surface 24.

The one or more fiber ribbons 12 include a plurality of optical fibers. The one or more fiber ribbons 12 have a first end 12a and a second end opposite to the first end 12a. The plurality of optical fibers are optically coupled to the optical path conversion component 11 at the first end 12a. The fiber ribbon 12 is an example of a first fiber ribbon in the present disclosure.

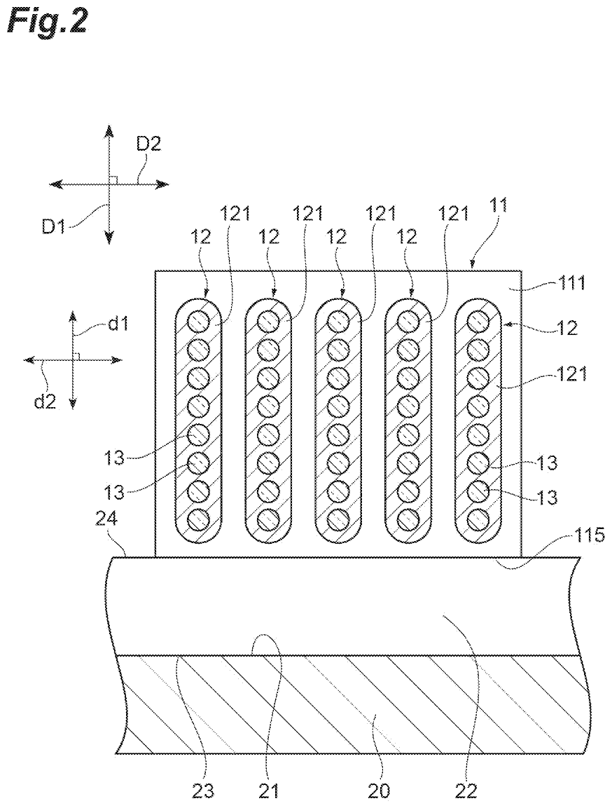

FIG. 2 is a cross-sectional view along the line II-II shown in FIG. 1, and shows the cross sections of the fiber ribbons 12 and the circuit board 20. As shown in FIG. 2, in the fiber ribbon 12, a plurality of optical fibers 13 are arranged side by side in a row along a direction d1 crossing the optical axis direction (direction perpendicular to the paper surface) of each optical fiber 13. The plurality of optical fibers 13 are collectively held by a resin coating 121. The number of optical fibers 13 held in one fiber ribbon 12 varies, for example, 4, 8, 12, and so on. FIG. 2 shows a case where the number of optical fibers 13 is the same in the plurality of fiber ribbons 12. In at least two fiber ribbons 12, the number of optical fibers 13 may be different. In the following description, the arrangement direction d1 of the plurality of optical fibers 13 is defined as the width direction of the fiber ribbon 12, and a direction d2 perpendicular to the arrangement direction d1 is defined as the thickness direction of the fiber ribbon 12.

In the present embodiment, one or more fiber ribbons 12 extend from the optical fiber connection surface 111 of the optical path conversion component 11 along a direction D3 in a state in which the thickness direction d2 of each fiber ribbon 12 crosses the normal direction common to the main surface 21 and the bottom surface 115, in other words, the width direction d1 of each fiber ribbon 12 crosses the main surface 21 and the bottom surface 115. The direction D3 is a direction crossing the normal common to the main surface 21 and the bottom surface 115. The direction D3 may be parallel to the main surface 21 and the bottom surface 115 or may be inclined with respect to the main surface 21 and the bottom surface 115, and it is realistic that the direction D3 is inclined within 30°. In one example, the direction D3 is approximately perpendicular to the normal direction common to the main surface 21 and the bottom surface 115. As shown in FIG. 1, the plurality of fiber ribbons 12 are arranged side by side along the direction D2. The direction D2 crosses the direction D3, and is a direction along the main surface 21 and the bottom surface 115. In one example, the direction D2 is parallel to the main surface 21 and the bottom surface 115, and the directions D2 and D3 are perpendicular to each other.

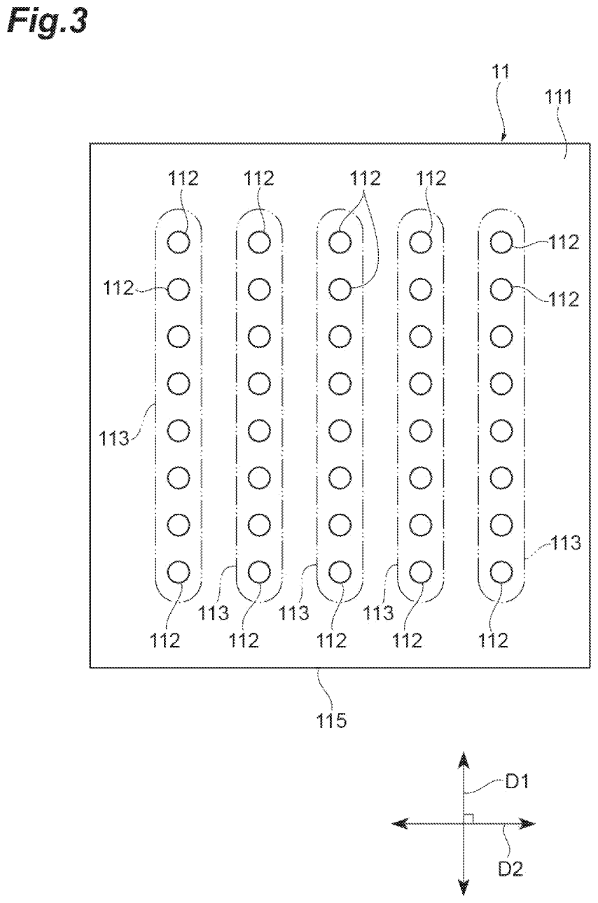

FIG. 3 is a front view showing the optical fiber connection surface 111 of the optical path conversion component 11. A plurality of channels 112 to which the plurality of optical fibers 13 are optically coupled are provided on the optical fiber connection surface 111. Specifically, the optical path conversion component 11 has at least one channel group 113, which includes a plurality of channels 112 optically coupled to the plurality of optical fibers 13, for each of the one or more fiber ribbons 12 on the optical fiber connection surface 111. The plurality of channels 112 are arranged along the direction D1, which crosses the main surface 21 or is approximately perpendicular to the main surface 21, for each of at least one channel group 113. The direction D1 crosses both the directions D2 and D3, and in one example, is perpendicular to both the directions D2 and D3. The direction D1 may be the same as the normal direction of the main surface 21. On the optical fiber connection surface 111, at least two (all in the illustrated example) channel groups 113 are arranged along the direction D2. FIG. 3 shows a case where the number of channels 112 is the same in a plurality of channel groups 113. In at least two channel groups 113, the number of channels 112 may be different.

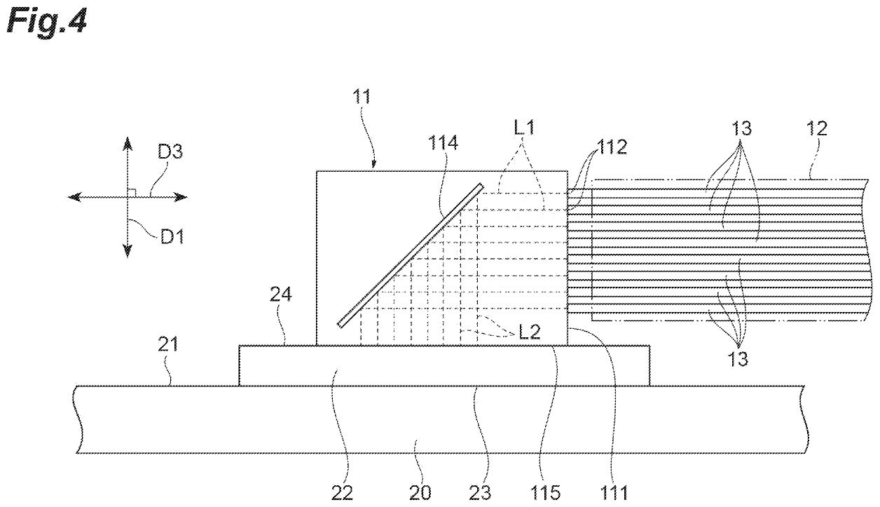

FIG. 4 is a side view of the optical path conversion component 11. As shown in FIG. 4, the optical path conversion component 11 has a plurality of optical paths L1 (first optical paths), a plurality of optical paths L2 (second optical paths), and an optical path converting portion 114. The plurality of optical paths L1 extend from the plurality of channels 112 of at least one channel group 113 in parallel with each other in the optical axis direction of the optical fiber 13. The optical paths L1 reach the optical path converting portion 114 from the optical fiber connection surface 111. The optical paths L1 may be parallel to the main surface 21 and the bottom surface 115, or may be inclined with respect to the main surface 21 and the bottom surface 115.

The plurality of optical paths L2 extend from a plurality of optical ports provided on the surface 24 of the optical device 22 along a direction (direction D1 in the illustrated example) crossing the main surface 21 and the bottom surface 115. The optical paths L2 reach the optical path converting portion 114 from the bottom surface 115. The optical path converting portion 114 connects the optical paths L1 and L2 to each other. For example, the optical path converting portion 114 comprises a light reflecting surface. The optical path converting portion 114 changes the direction of light propagating through the optical path L1 to guide the light to the optical path L2, and changes the direction of light propagating through the optical path L2 to guide the light to the optical path L1. In this case, the light reflecting surface is provided along a plane that is inclined with respect to both the extending directions of the optical paths L1 and L2. With such a configuration, the optical path conversion component 11 optically couples each of the plurality of optical ports of the optical device 22 and each of the plurality of optical fibers 13.

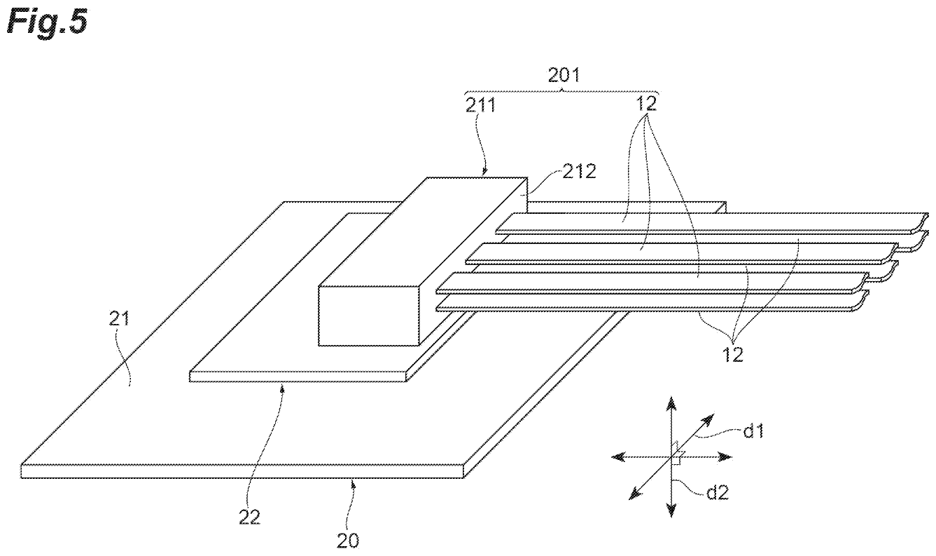

The effects obtained by the mounting circuit board 1A and the wiring module 10A of the present embodiment having the above configurations will be described. FIG. 5 is a perspective view showing a wiring module 201 according to a comparative example. In the wiring module 201, a plurality of fiber ribbons 12 extend from an optical fiber connection surface 212 of an optical path conversion component 211 in such a manner that the thickness direction d2 matches the normal of the main surface 21. In this case, the thickness direction d2 of the plurality of fiber ribbons 12 is the same as a direction crossing the arrangement direction d1 of the optical fibers 13, and the width direction is the same as the arrangement direction d1 of the optical fibers. Generally, the fiber ribbon 12 has a characteristic that the flexibility in the thickness direction d2 is high and the flexibility in the width direction is low. In the comparative example shown in FIG. 5, the width direction d1 of the fiber ribbon 12 is along the main surface 21 of the circuit board 20. Therefore, it is difficult to bend the fiber ribbon 12 in a direction parallel to the main surface 21, which imposes restrictions on the design of the circuit board 20. Even if the fiber ribbon 12 can be bent by twisting, there is a concern that the transmission loss may increase due to the torsional stress.

In view of such a problem, in the mounting circuit board 1A and the wiring module 10A of the present embodiment, a plurality of channels 112 optically coupled to the plurality of optical fibers 13 forming the fiber ribbon 12 are arranged along the direction D1 crossing the main surface 21 of the circuit board 20 and the bottom surface 115 of the optical path conversion component 11. In this case, the fiber ribbon 12 extends from the optical path conversion component 11 in a direction crossing the normal of the main surface 21 of the circuit board 20 in such a manner that the thickness direction d2 crosses the normal of the main surface 21. Therefore, the fiber ribbon 12 can be easily bent in a direction parallel to the main surface 21 of the circuit board 20. As a result, the restrictions on the design of the circuit board 20 can be reduced, and the increase in transmission loss due to torsional stress or the like can be suppressed.

As in the present embodiment, the optical path conversion component 11 has the optical path L1, the optical path L2, and the optical path converting portion 114, and may optically couple the optical device 22 to the plurality of optical fibers 13. The optical path L1 extends from the plurality of channels 112 in parallel with the optical axis of the optical fiber 13. The optical path L2 extends from the optical device 22 provided on the main surface 21 in a direction crossing the main surface 21. The optical path converting portion 114 connects the optical paths L1 and L2 to each other. In this case, the optical device 22 on the circuit board 20 facing the bottom surface 115 of the optical path conversion component 11 can be efficiently coupled to the plurality of optical fibers 13.

As in the present embodiment, the optical path conversion component 11 may have a plurality of channel groups 113, and at least two channel groups 113 may be arranged in the direction D2 along the main surface 21 and the bottom surface 115. In this case, since the plurality of fiber ribbons 12 are arranged so as to overlap each other in the thickness direction d2, the wiring density of the fiber ribbons 12 can be increased.

### First Modification Example

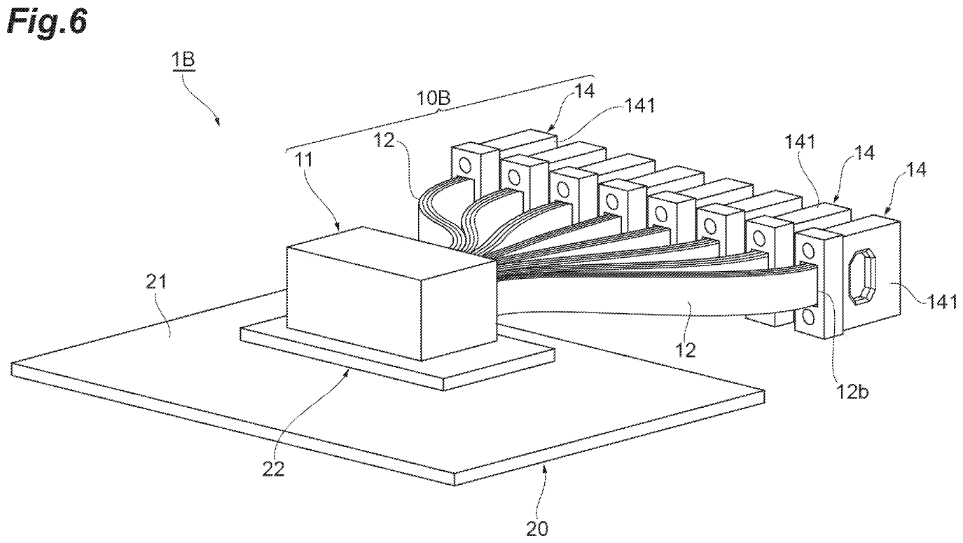

FIG. 6 is a perspective view showing the configuration of a mounting circuit board 1B according to a first modification example of the present embodiment. As shown in FIG. 6, the mounting circuit board 1B of the first modification includes a wiring module 10B instead of the wiring module 10A of the present embodiment. The wiring module 10B further includes a multi-fiber optical connector 14 in addition to the optical path conversion component 11 and the fiber ribbon 12 of the present embodiment. The multi-fiber optical connector 14 is an example of a first multi-fiber optical connector in the present disclosure. One multi-fiber optical connector 14 is provided every n fiber ribbons 12, and is attached to the second end 12b of the fiber ribbons 12. n is an integer of 1 or more, and n=3 in the illustrated example. In the illustrated example, the multi-fiber optical connector 14 is attached to all the fiber ribbons 12. In the first modification example, it is sufficient that the multi-fiber optical connector 14 is attached to at least one fiber ribbon 12. An optical component different from the multi-fiber optical connector 14 may be attached to the second ends 12b of some of the fiber ribbons 12. The multi-fiber optical connector 14 is, for example, an MT (Mechanically Transferable) type optical connector, and includes an MT ferrule 141. When the number of optical fibers 13 included in each fiber ribbon 12 is in, the MT ferrule 141 holds in rows of optical fibers 13 over n columns.

As in the first modification example, the multi-fiber optical connector 14 may be attached to the second end 12b of at least one fiber ribbon 12. In this case, the fiber ribbon 12 and another fiber ribbon can be easily connected to each other.

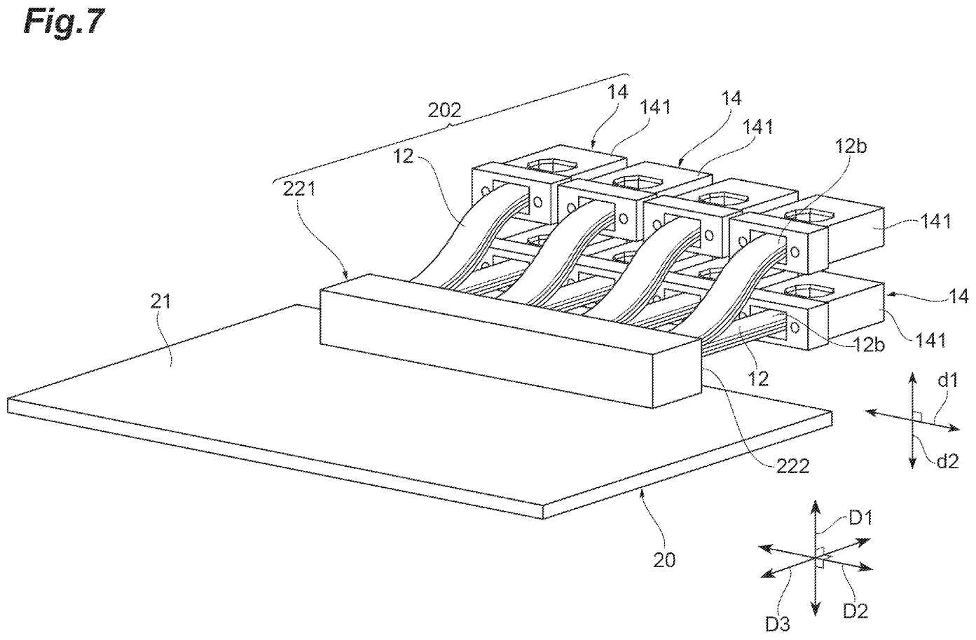

Here, FIG. 7 is a perspective view showing a wiring module 202 according to a comparative example. In the wiring module 202, a plurality of fiber ribbons 12 extend from an optical fiber connection surface 222 of an optical path conversion component 221 in such a manner that the thickness direction d2 matches the normal of the main surface 21. Then, the MT ferrule 141 of the multi-fiber optical connector 14 is attached to the second end 12b of the plurality of fiber ribbons 12.

Generally, the multi-fiber optical connector 14 has a certain width and thickness around the fiber ribbon 12. In addition, as described with reference to FIG. 5, the fiber ribbon 12 is difficult to bend in the width direction d1. Therefore, when the multi-fiber optical connectors 14 are arranged along the width direction d1, the center spacing (pitch) between the channel groups adjacent to each other on the optical fiber connection surface 222 increases by the size of the multi-fiber optical connector 14 in the width direction. Therefore, when a plurality of fiber ribbons 12 are arranged in such a manner that the thickness direction d2 matches the normal of the main surface 21 as in this modification example, a plurality of channel groups of the optical fiber connection surface 222 are sparsely arranged in the direction D2 in which the fiber ribbons 12 are arranged. For this reason, the optical path conversion component 221 becomes large.

On the other hand, in the first modification example, the plurality of fiber ribbons 12 are arranged in such a manner that the thickness direction d2 crosses the normal of the main surface 21. As a result, as shown in FIG. 6, the fiber ribbons 12 can be easily bent in the arrangement direction D2. Therefore, regardless of the size of the multi-fiber optical connector 14, the plurality of channel groups 113 of the optical path conversion component 11 can be densely arranged, which can contribute to the miniaturization of the optical path conversion component 11.

### Second Modification Example

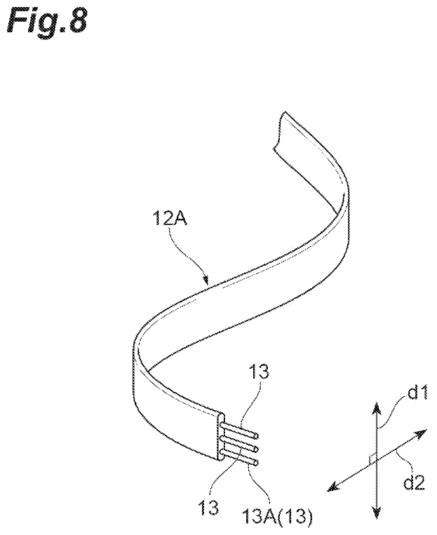

FIG. 8 is a perspective view showing a fiber ribbon 12A according to a second modification example of the present embodiment. At least one optical fiber 13A of the plurality of optical fibers 13 forming the fiber ribbon 12A shown in FIG. 8 is a stress-applied type polarization maintaining fiber. At least one of the plurality of fiber ribbons 12 of the present embodiment may be replaced with the fiber ribbon 12A of the second modification example.

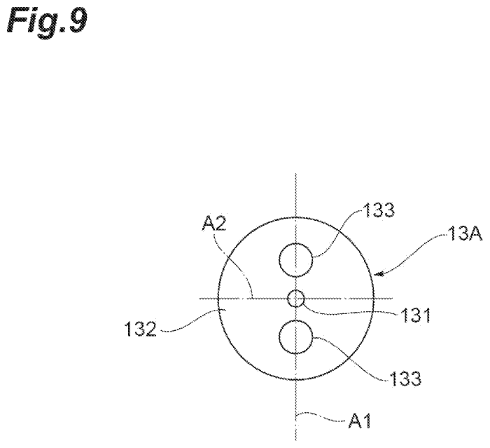

FIG. 9 is a diagram schematically showing a cross section of an optical fiber 13A perpendicular to the optical axis direction. As shown in FIG. 9, the optical fiber 13A that is a polarization maintaining fiber has a core 131 provided on the central axis of the optical fiber 13A, a clad 132 provided around the core 131, and a pair of stress applying portions 133 arranged on a single diameter with the core 131 interposed therebetween. The cross-sectional shape of the pair of stress applying portions 133 is an arbitrary shape, such as a circle. The axis along the arrangement direction of the pair of stress applying portions 133 is a slow axis A1, and the axis perpendicular to the slow axis A1 is a fast axis A2.

In the second modification example, the relative angle of the optical fiber 13A with respect to the fiber ribbon 12A is adjusted so that the fast axis A2 of the optical fiber 13A extends along the arrangement direction d1 of the plurality of optical fibers 13 forming the fiber ribbon 12A. In one example, the fast axis A2 of the optical fiber 13A is made to match the arrangement direction d1 of the plurality of optical fibers 13. Alternatively, the fast axis A2 of the optical fiber 13A may form an angle of manufacturing error, for example, about ±10° with respect to the arrangement direction d1 of the plurality of optical fibers 13.

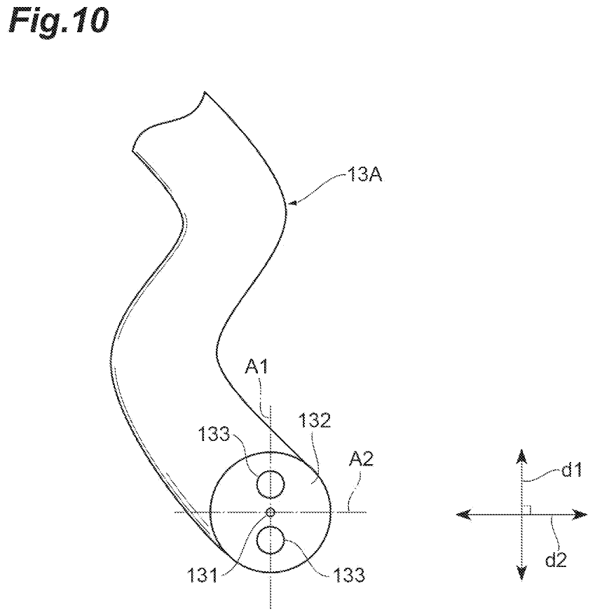

Here, FIG. 10 is a diagram showing how the optical fiber 13A is bent in a direction along the fast axis A2. When the fast axis A2 of the optical fiber 13A crosses the arrangement direction d1 of the plurality of optical fibers 13 forming the fiber ribbon 12A, the optical fiber 13A is bent mainly in the direction along the fast axis A2. Therefore, when the optical fiber 13A is bent, the birefringence of the optical fiber 13A decreases, which may increase polarization crosstalk.

On the other hand, according to the second modification example, since the thickness direction d2 of the fiber ribbon 12A crosses the fast axis A2 of the optical fiber 13A, the optical fiber 13A is bent mainly in the direction crossing the fast axis A2. In this case, since the birefringence increases when the optical fiber 13A is bent, it is possible to suppress the increase in polarization crosstalk.

### Third Modification Example

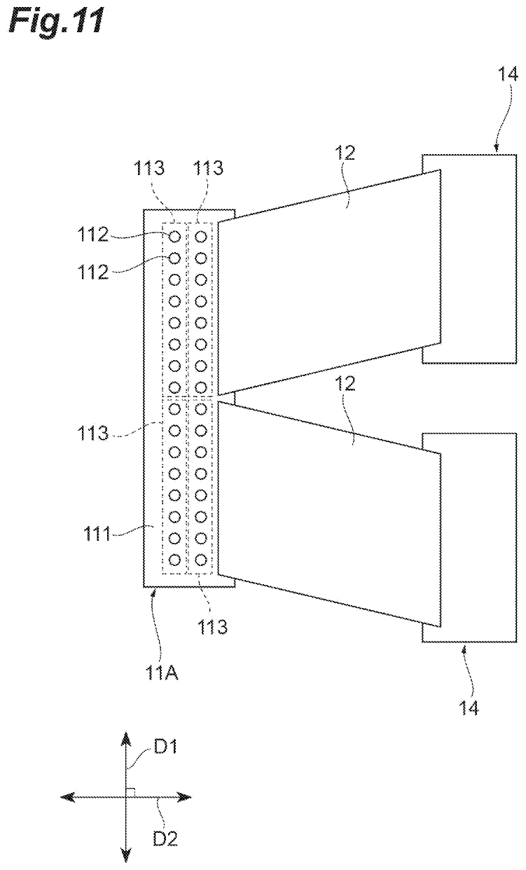

FIG. 11 is a diagram schematically showing an optical path conversion component 11A, fiber ribbons 12, and multi-fiber optical connectors 14 according to a third modification of the present embodiment. In the third modification example, the optical path conversion component 11A has a plurality of channel groups 113 on the optical fiber connection surface 111. Then, one channel group 113 is arranged in the direction D1 crossing the main surface 21 or approximately perpendicular to the main surface 21, or at least two channel groups 113 are arranged along the direction D1. In the illustrated example, a plurality of channel group rows each including two channel groups 113 arranged along the direction D1 are arranged along the direction D2. In this case, since at least two fiber ribbons 12 can be arranged side by side in the direction D1, the space on the circuit board 20 can be effectively used to increase the wiring density of the fiber ribbons 12.

In addition, the total number of channels 112 arranged along the direction D1 in the optical path conversion component 11A is equal to the total number of channels 112 forming at least one channel group 113 in the direction D1. In other words, in the plurality of channels 112 arranged along the direction D1, there is no channel 112 that does not consist the channel group 113. For example, in the illustrated example, two channel groups 113 each consisting of eight channels 112 are provided side by side in the direction D1. Therefore, the total number of channels 112 forming the channel group 113 in the direction D1 is 16. On the other hand, the total number of channels 112 arranged along the direction D1 in the optical path conversion component 11A is also 16. In particular, when the number of optical fibers 13 included in each fiber ribbon 12 is the same in the plurality of fiber ribbons 12, the total number of channels 112 arranged along the direction D1 in the optical path conversion component 11A may be an integral multiple of the number of optical fibers 13 of each fiber ribbon 12.

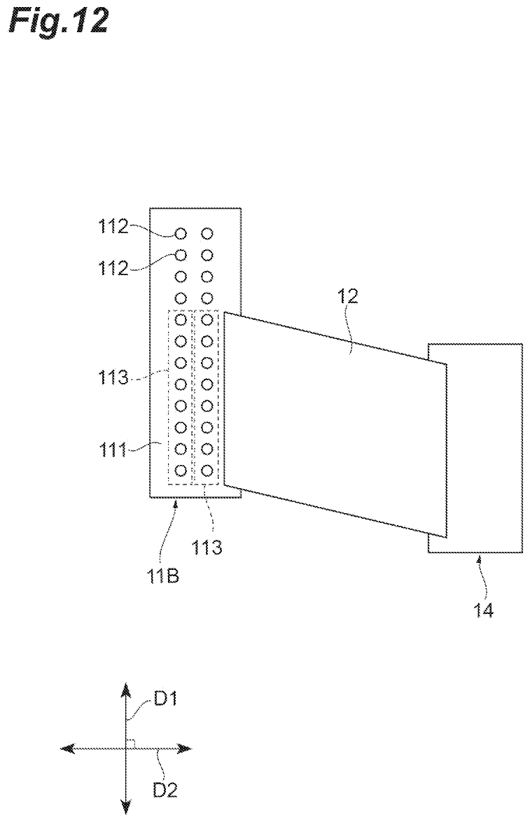

As a comparative example, FIG. 12 is a diagram showing a case where the total number of channels 112 arranged along the direction D1 in an optical path conversion component 11B is different from the total number of channels 112 forming at least one channel group 113 arranged along the direction D1. In this example, since only one channel group 113 including eight channels 112 is provided in the direction D1, the total number of channels 112 forming the channel group 113 in the direction D1 is 8. On the other hand, the total number of channels 112 arranged along the direction D1 in the optical path conversion component 11B is 12. Therefore, four channels 112 of the twelve channels 112 arranged along the direction D1 do not consist the channel group 113 and are not connected to the optical fiber 13. Thus, when the extra channel 112 that is not connected to the optical fiber 13 is present in the optical path conversion component 11B, the space utilization efficiency of the optical path conversion component 11B is reduced, which is an obstacle to the miniaturization of the optical path conversion component 11B.

On the other hand, in the third modification example shown in FIG. 11, the total number of channels 112 arranged along the direction D1 is equal to the total number of channels 112 forming at least one channel group 113 in the direction D1. In this case, all the channels 112 arranged along the direction D1 are connected to any of the fiber ribbons 12, and there is no surplus in the channels 112. Therefore, it is possible to improve the space utilization efficiency of the optical path conversion component 11A to contribute to the miniaturization of the optical path conversion component 11A.

### Fourth Modification Example

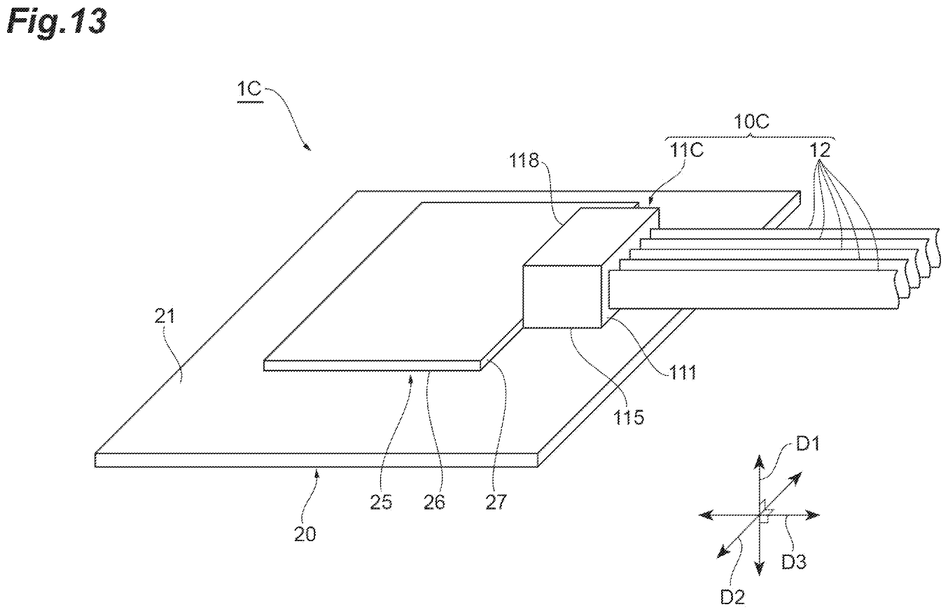

FIG. 13 is a perspective view showing the configuration of a mounting circuit board 1C according to a fourth modification example of the present embodiment. As shown in FIG. 13, the mounting circuit board 1C of the fourth modification example includes an optical device 25 instead of the optical device 22 of the present embodiment. In addition, the mounting circuit board 1C of the fourth modification example includes a wiring module 10C instead of the wiring module 10A. The optical device 25 may include, for example, at least one of a semiconductor light receiving element such as a photodiode, a semiconductor light emitting element such as a laser diode or an LED, and an optical waveguide chip. The optical device 25 of the fourth modification example is provided on the main surface 21 of the circuit board 20, and has a back surface 26 facing the main surface 21 and a side surface 27. The optical device 25 has a plurality of optical ports for the input and output of continuous light or an optical signal on the side surface 27.

The wiring module 10C includes an optical path conversion component 11C and one or more (five in the illustrated example) fiber ribbons 12. The optical path conversion component 11C is mounted on the main surface 21 of the circuit board 20 and connected to the circuit board 20. Specifically, the optical path conversion component 11C has an optical fiber connection surface 111, an optical device connection surface 118, and a bottom surface 115. The bottom surface 115 faces a region of the main surface 21 adjacent to the mounting region of the optical device 25 and is fixed to the region. The normal direction of the optical device connection surface 118 and the normal direction of the bottom surface 115 cross each other. The optical device connection surface 118 faces the side surface 27 of the optical device 25 and is optically coupled to a plurality of optical ports provided on the side surface 27. In one example, the optical fiber connection surface 111 and the optical device connection surface 118 face opposite to each other. The optical fiber connection surface 111 and the optical device connection surface 118 may be parallel to each other.

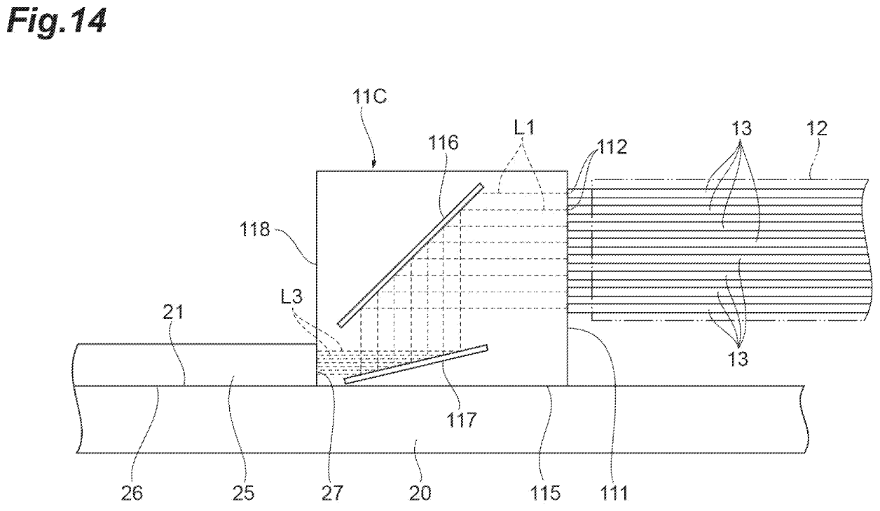

FIG. 14 is a side view of the optical path conversion component 11C. As shown in FIG. 14, the optical path conversion component 11C has a plurality of optical paths L1 (first optical paths), a plurality of optical paths L3 (second optical paths), and optical path converting portions 116 and 117. The plurality of optical paths L1 extend from the plurality of channels 112 of at least one channel group 113 in parallel with each other in the optical axis direction of the optical fibers 13. The optical paths L1 reach the optical path converting portion 116 from the optical fiber connection surface 111. The optical paths L1 may be parallel to the main surface 21 and the bottom surface 115, or may be inclined with respect to the main surface 21 and the bottom surface 115.

The plurality of optical paths L3 extend from a plurality of optical ports provided on the side surface 27 of the optical device 25 along the main surface 21 and the bottom surface 115. The optical paths L3 reach the optical path converting portion 117 from the optical device connection surface 118. The optical path converting portions 116 and 117 connect the optical paths L1 and L3 to each other. For example, each of the optical path converting portions 116 and 117 comprises a light reflecting surface. The light propagating from the optical fiber connection surface 111 through the optical path L1 is changed in direction by the optical path converting portion 116 and is then changed in direction again by the optical path converting portion 117 to be guided to the optical path L3. The light propagating from the optical device connection surface 118 through the optical path L3 is changed in direction by the optical path converting portion 117 and is then changed in direction again by the optical path converting portion 116 to be guided to the optical path L1. In this case, the light reflecting surfaces of the optical path converting portions 116 and 117 are provided along a plane that is inclined with respect to both the extending directions of the optical paths L1 and L3. With such a configuration, the optical path conversion component 11C optically couples each of the plurality of optical ports of the optical device 25 to each of the plurality of optical fibers 13.

As in the fourth modification example, the optical path conversion component 11C may have the optical path converting portions 116 and 117 that connect the optical path L1 and the optical path L3 to each other and optically couple the optical device 25 to the plurality of optical fibers 13. The optical path L1 extends from the plurality of channels 112 in parallel with the optical axis of the optical fiber 13. The optical path L3 extends from the optical device 25 in parallel with the main surface 21. Even in such a case, the optical device 25 on the circuit board 20 can be efficiently coupled to the plurality of optical fibers 13. It is not always necessary to provide two optical path converting portions. For example, instead of the light reflecting surface, a curved waveguide may be provided. In this case, the number of optical path converting portions can be reduced.

### Fifth Modification Example

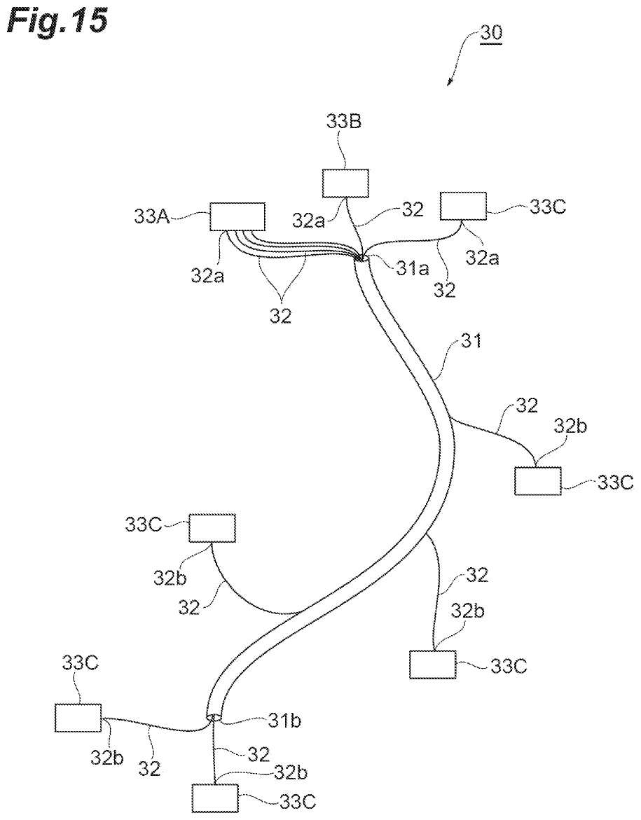

FIG. 15 is a diagram showing a harness 30 according to a fifth modification example of the present embodiment. The mounting circuit board may include the harness 30 shown in FIG. 15 in addition to the configuration of the first modification example shown in FIG. 6.

The harness 30 includes a plurality of fiber ribbons 32 (second fiber ribbons). Each fiber ribbon 32 has a first end 32a and a second end 32b. Portions of the plurality of fiber ribbons 32 excluding the first end 32a and the second end 32b are collectively bundled by a tube 31. In the illustrated example, the first ends 32a of all the fiber ribbons 32 extend from a first end 31a of the tube 31 to the outside of the tube 31. Without being limited to the illustrated example, the first ends 32a of some fiber ribbons 32 among the plurality of fiber ribbons 32 may extend from the first end 31a of the tube 31 to the outside of the tube 31. Then, the first ends 32a of the other fiber ribbons 32 may extend from the side surface of the tube 31 between the first end 31a and the second end 31b to the outside of the tube 31. In the illustrated example, the second ends 32b of some fiber ribbons 32 among the plurality of fiber ribbons 32 extend from the second end 31b of the tube 31 to the outside of the tube 31. The second ends 32b of the other fiber ribbons 32 extend from the side surface of the tube 31 between the first end 31a and the second end 31b to the outside of the tube 31. Without being limited to the illustrated example, the second ends 32b of all the fiber ribbons 32 may extend from the second end 31b of the tube 31 to the outside of the tube 31.

A so-called gang connector 33A, which can be collectively connected to the plurality of multi-fiber optical connectors 14 shown in FIG. 6, is attached to the first ends 32a of two or more fiber ribbons 32 among the plurality of fiber ribbons 32. The gang connector 33A is an example of a second multi-fiber optical connector in the present disclosure. A low mating force connector 33B, which is a multi-fiber optical connector, is attached to the first end 32a of another fiber ribbon 32. A multi-fiber optical connector 33C is attached to the first end 32a of still another fiber ribbon 32 and the second end 32b of each fiber ribbon 32.

A complicated optical connection structure can be easily assembled on the circuit board 20 by connecting the gang connector 33A (when there are a plurality of gang connectors 33A, at least one of the gang connectors 33A) of the harness 30 having such a configuration to a plurality of multi-fiber optical connectors 14. Instead of the gang connector 33A, a multi-fiber optical connector corresponding to each of the plurality of multi-fiber optical connectors 14 may be attached to the first end 32a of the fiber ribbon 32. Instead of at least one of the plurality of multi-fiber optical connectors 33C attached to the second ends 32b of the plurality of fiber ribbons 32, the gang connector 33A or the low mating force connector 33B may be attached. Instead of the low mating force connector 33B and the multi-fiber optical connector 33C, an optical path conversion component different from the optical path conversion component 11, another optical fiber connection device such as an optical fiber array, or an optical device different from the optical devices 22 and 25 may be optically coupled to the fiber ribbon 32.

### Sixth Modification Example

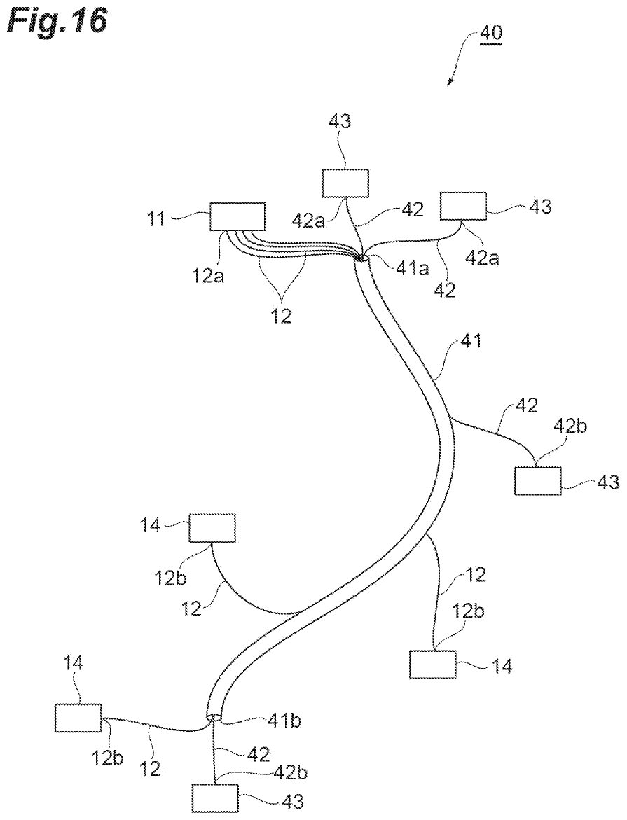

FIG. 16 is a diagram showing a harness 40 according to a sixth modification example of the present embodiment. The mounting circuit board may include the harness 40 shown in FIG. 16 in addition to the configuration of the first modification example shown in FIG. 6. The harness 40 includes at least one (plural in the illustrated example) fiber ribbons 12 shown in FIG. 6 and one or more fiber ribbons 42 (third fiber ribbons). Each fiber ribbon 42 has a first end 42a and a second end 42b. Portions of the plurality of fiber ribbons 12 excluding the first end 12a and the second end 12b and portions of the plurality of fiber ribbons 42 excluding the first end 42a and the second end 42b are collectively bundled by a tube 41. In the illustrated example, the first ends 12a of all the fiber ribbons 12 and the first ends 42a of all the fiber ribbons 42 extend from a first end 41a of the tube 41 to the outside of the tube 41. Without being limited to the illustrated example, the first ends 12a of some fiber ribbons 12 among the plurality of fiber ribbons 12 and the first ends 42a of some fiber ribbons 42 among the plurality of fiber ribbons 42 may extend from the first end 41a of the tube 41 to the outside of the tube 41. Then, the first ends 12a of the other fiber ribbons 12 and the first ends 42a of the other fiber ribbons 42 extend from the side surface of the tube 41 between the first end 41a and the second end 41b to the outside of the tube 41. In the illustrated example, the second ends 12b of some fiber ribbons 12 among the plurality of fiber ribbons 12 and the second ends 42b of some fiber ribbons 42 among the plurality of fiber ribbons 42 extend from the second end 41b of the tube 41 to the outside of the tube 41. The second ends 12b of the other fiber ribbons 12 and the second ends 42b of the other fiber ribbons 42 extend from the side surface of the tube 41 between the first end 41a and the second end 41b to the outside of the tube 41. Without being limited to the illustrated example, the second ends 12b of all the fiber ribbons 12 and the second ends 42b of all the fiber ribbons 42 may extend from the second end 41b of the tube 41 to the outside of the tube 41.

The optical path conversion component 11 of the present embodiment is optically coupled to the first end 12a of the fiber ribbon 12. The multi-fiber optical connector 14 is attached to the second end 12b of the fiber ribbon 12. A multi-fiber optical connector 43 is attached to the first end 42a and the second end 42b of the fiber ribbon 42.

By providing the harness 40 on the mounting circuit board as in the sixth modification example, a complicated optical connection structure can be easily assembled on the circuit board 20. Instead of the optical path conversion component 11 of the embodiment described above, the optical path conversion component 11A according to the third modification example (see FIG. 11) or the optical path conversion component 11C according to the fourth modification example (see FIGS. 13 and 14) may be optically coupled to the first end 12a of the fiber ribbon 12. Instead of the multi-fiber optical connector 14, an optical path conversion component different from the optical path conversion component 11 (11A, 11C), another optical fiber connection device such as an optical fiber array, or an optical device different from the optical devices 22 and 25 may be optically coupled to the second end 12b of the fiber ribbon 12. In addition, instead of the multi-fiber optical connector 43, an optical path conversion component different from the optical path conversion component 11 (11A, 11C), another optical fiber connection device such as an optical fiber array, or an optical device different from the optical devices 22 and 25 may be optically coupled to at least one of the first end 42a and the second end 42b of the fiber ribbon 42.

### Seventh Modification Example

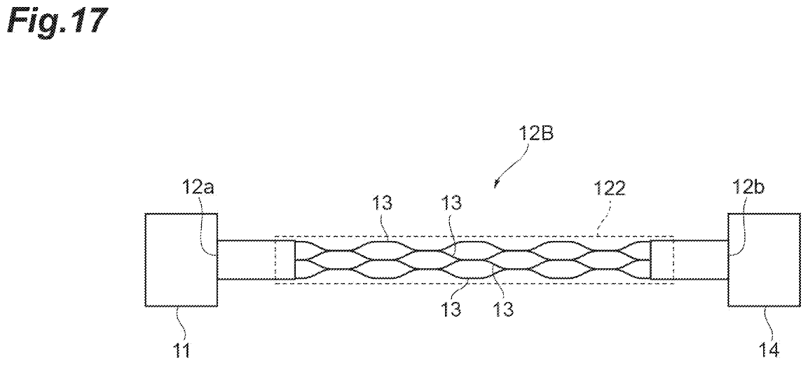

FIG. 17 is a diagram schematically showing the configuration of a fiber ribbon 12B according to a seventh modification example of the present embodiment. The fiber ribbon 12 of the present embodiment may be replaced with the fiber ribbon 12B of the seventh modification example. As shown in FIG. 17, the first end 12a of the fiber ribbon 12B is optically coupled to the optical path conversion component 11, and the multi-fiber optical connector 14 is attached to the second end 12b. The fiber ribbon 12B is configured to include a plurality of optical fibers 13. The plurality of optical fibers 13 are covered with a flexible tubular cover 122 in a section between the first end 12a and the second end 12b. In the section covered by the cover 122, the optical fibers 13 adjacent to each other are intermittently bonded to each other. Alternatively, in the section covered by the cover 122, the optical fibers 13 adjacent to each other may be separated from each other. By providing such a fiber ribbon 12B in the wiring module 10A, 10B, or 10C, the fiber ribbon can be easily bent in the width direction d1 of the fiber ribbon. As a result, it is possible to further increase the degree of freedom of optical wiring.

The circuit board with an optical path conversion component and the wiring module for mounting on a circuit board according to the present disclosure are not limited to the above-described embodiment and each modification example, and various modifications can be made. For example, in the present embodiment, the first optical path and the second optical path are optically coupled to each other through an optical path converting portion. The first optical path and the second optical path may be optically coupled to each other through a bent optical fiber. The optical fiber is optically coupled to the first optical path on the optical fiber connection surface that is one surface of the optical path conversion component, but may be optically coupled inside the optical path conversion component. In the present embodiment and each modification example, the configuration of the present disclosure is applied to the fiber ribbon in which optical fibers are arranged in a row. The configuration of the present disclosure can also be applied to a fiber ribbon in which optical fibers are arranged in two or more rows. In this case, the plurality of channels of the optical path conversion component may be arranged for each channel group with the direction crossing the main surface as a main arrangement direction, that is, a direction in which a large number of channels are arranged. In the present embodiment and each modification example, the first optical path and the optical axis direction of the optical fiber extend in parallel with each other. Even if there is an inclination between the first optical path and the optical axis direction of the optical fiber because the end face of the optical fiber is not perpendicular to the optical fiber axis due to manufacturing error or the like or because the refractive indices of the optical path conversion component and the optical fiber are different, the configuration of the present disclosure can be applied as long as the first optical path is optically coupled to the optical fiber.

### REFERENCE SIGNS LIST

1A, 1B, 1C: circuit board with optical path conversion component
10, 10A, 10B, 10C: wiring module for mounting on circuit board
11, 11A, 11B, 11C: optical path conversion component
12, 12A, 12B: fiber ribbon (first fiber ribbon)
12a: first end
12b: second end
13, 13A: optical fiber
14: multi-fiber optical connector
20: circuit board
21: main surface
22, 25: optical device
23, 26: back surface
24: surface
27: side surface
30, 40: harness
31, 41: tube
31a, 41a: first end
31b, 41b: second end
32: fiber ribbon (second fiber ribbon)
32a: first end
32b: second end
33A: gang connector
33B: low mating force connector
33C: multi-fiber optical connector
42: fiber ribbon (third fiber ribbon),
42a: first end
42b: second end
43: multi-fiber optical connector
111: optical fiber connection surface
112: channel
113: channel group
114, 116, 117: optical path converting portion
115: bottom surface
118: optical device connection surface
121: resin coating
131: core
132: clad
133: stress applying portion
141: MT ferrule
A1: slow axis
A2: fast axis
d1: optical fiber arrangement direction (fiber ribbon width direction)
d2: fiber ribbon thickness direction
D1, D2, D3: direction
L1: optical path (first optical path)
L2, L3: optical path (second optical path).

1. A circuit board with an optical path conversion component, comprising:
a circuit board having a main surface;
an optical path conversion component connected to the circuit board; and
one or more first fiber ribbons each of which has a first end and a second end and includes a plurality of optical fibers optically coupled to the optical path conversion component at the first end,
wherein the one or more first fiber ribbons extend in a direction crossing a normal of the main surface,
the optical path conversion component has at least one channel group for each of the one or more first fiber ribbons, the at least one channel group including a plurality of channels optically coupled respectively to the plurality of optical fibers, and
the plurality of channels are arranged in a direction crossing the main surface for each of the at least one channel group.

2. The circuit board with an optical path conversion component according to claim 1,
wherein the optical path conversion component has first optical paths extending from the plurality of channels in parallel with an optical axis of the respective optical fibers, second optical paths extending from an optical device provided on the main surface in a direction crossing the main surface, and an optical path converting portion for connecting the first and second optical paths to each other, and optically couples the optical device to the plurality of optical fibers.

3. The circuit board with an optical path conversion component according to claim 1,
wherein the optical path conversion component has first optical paths extending from the plurality of channels in parallel with an optical axis of the respective optical fibers, second optical paths extending from an optical device provided on the main surface in parallel with the main surface, and an optical path converting portion for connecting the first and second optical paths to each other, and optically couples the optical device and the plurality of optical fibers.

4. The circuit board with an optical path conversion component according to claim 2,
wherein the optical path converting portion comprises at least one light reflecting surface.

5. The circuit board with an optical path conversion component according to claim 1,
wherein the one or more first fiber ribbons extend in an inclination direction within 45° with respect to the main surface.

6. The circuit board with an optical path conversion component according to claim 1,
wherein the at least one channel group includes at least two first channel groups arranged in a direction along the main surface.

7. The circuit board with an optical path conversion component according to claim 1,
wherein the at least one channel group includes at least two second channel groups arranged in a direction crossing the main surface.

8. The circuit board with an optical path conversion component according to claim 1,
wherein a total number of channels arranged in a direction crossing the main surface in the optical path conversion component is equal to a total number of channels forming each of the at least one channel group in the direction crossing the main surface.

9. The circuit board with an optical path conversion component according to claim 1,
wherein, plurality of optical fibers forming at least one first fiber ribbon among the one or more first fiber ribbons include at least one stress-applied type polarization maintaining fiber, and
a fast axis of the polarization maintaining fiber is along an arrangement direction of the plurality of optical fibers forming the at least one first fiber ribbon including the polarization maintaining fiber.

10. The circuit board with an optical path conversion component according to claim 1, the circuit board further comprising:
a first multi-fiber optical connector attached to the second end of at least one first fiber ribbon among the one or more first fiber ribbons.

11. The circuit board with an optical path conversion component according to claim 10, further comprising:
a harness in which a plurality of second fiber ribbons each having a first end and a second end are bundled,
wherein a second multi-fiber optical connector is attached to the first end of at least one second fiber ribbon among the plurality of second fiber ribbons, and
the second multi-fiber optical connector is connected to the first multi-fiber optical connector.

12. The circuit board with an optical path conversion component according to claim 10, comprising:
a harness in which the at least one first fiber ribbon having the first multi-fiber optical connector and one or more third fiber ribbons are bundled.

13. A wiring module for mounting on a circuit board, comprising:
an optical path conversion component having a bottom surface and configured to be mounted on a main surface of a circuit board; and
one or more first fiber ribbons each of which has a first end and a second end and includes a plurality of optical fibers optically coupled to the optical path conversion component at the first end,
wherein the optical path conversion component has at least one channel group for each of the one or more first fiber ribbons, the at least one channel group including a plurality of channels optically coupled respectively to the plurality of optical fibers, and
the plurality of channels are arranged in a direction crossing the bottom surface for each of the at least one channel group.

14. The wiring module for mounting on a circuit board according to claim 13,
wherein the optical path conversion component has first optical paths extending from the plurality of channels in parallel with an optical axis of the respective optical fibers, second optical paths extending in a direction crossing the bottom surface, and an optical path converting portion for connecting the first and second optical paths to each other.

15. The wiring module for mounting on a circuit board according to claim 14,
wherein the optical path converting portion comprises at least one light reflecting surface.

16. The wiring module for mounting on a circuit board according to claim 13,
wherein the at least one channel group includes at least two channel groups arranged in a direction along the bottom surface.

17. The wiring module for mounting on a circuit board according to claim 13,
wherein, the plurality of optical fibers forming at least one first fiber ribbon among the one or more first fiber ribbons include at least one stress-applied type polarization maintaining fiber, and
a fast axis of the polarization maintaining fiber is along an arrangement direction of the plurality of optical fibers forming the at least one first fiber ribbon including the polarization maintaining fiber.

18. The circuit board with an optical path conversion component according to claim 3,
wherein the optical path converting portion comprises at least one light reflecting surface.

19. The circuit board with an optical path conversion component according to claim 2,
wherein the one or more first tape fibers extend in an inclination direction within 45° with respect to the main surface.

20. The circuit board with an optical path conversion component according to claim 3,
wherein the one or more first tape fibers extend in an inclination direction within 45° with respect to the main surface.
